(19) United States
(12) Patent Application Publication
(10) Pub. No.: US 2012/0249307 A1
(43) Pub. Date: Oct. 4, 2012

(54) Method and System of Tracking Hotel Linen Products

(76) Inventors: Jonathan Eisenberg, Miami, FL (US); William Serbin, Miami, FL (US)

(21) Appl. No.: 13/523,911

(22) Filed: Jun. 15, 2012

Related U.S. Application Data
(63) Continuation-in-part of application No. 12/239,840, filed on Sep. 29, 2008, now Pat. No. 8,229,801.

(51) Int. Cl. G08C 17/02

(52) U.S. Cl. 340/10.1

(57) ABSTRACT

A tracking system for tracking hotel linen includes a tracking control, a plurality of check points setting at different key locations in a hotel respectively to communicatively link with the tracking control, and a plurality of identification tags arranged for permanently affixing at a plurality of hotel linen products respectively. Each of the identification tags contains a unique code preset by the tracking control to wirelessly communicate with each of the check points. Therefore, when each of the hotel linen products is moved to one of the check points, the corresponding identification tag is registered thereat. A tracking record is generated in the tracking control for the hotel linen products in responsive to each of the check points to monitor and manage the hotel linen products so as to greatly improve linen utilization in the hotel.

### CROSS REFERENCE TO RELATED APPLICATIONS

This application is a continuation in part application of U.S. patent application Ser. No. 12/239,840 filed Sep. 29, 2008, having the titled “Method and System of Tracking Hotel Linen Products”, which is herein incorporated in its entirely.

### BACKGROUND

1. Field of the Invention

The present invention relates to a tracking system. More particularly, the method and system of tracking hotel moveable assets, including hotel linen products, such as sheets, towels, and bathrobes, efficiently in order to enhance the guest experience and to simplify the inventory management process in the hotel environment.

2. Discussion of the Related Art

In the United States, there are over 10,000 hotels of various sizes. One of the largest expenses of room occupancy is operating supplies. Major hotel brands are operating without knowing what the true cost of these supplies are. Some hotels are utilizing on-site laundry facilities, while other are outsourcing. Both have limited control of their linen and other supplies. Linen inventories of many properties are shrinking due to laundry damage, theft by guests, and staff and not to mention normal wear and tear. In today's competitive businesses, luxury hotels and resorts depend upon room presentation to raise the guest expectation and gain the competitive advantage.

Hotel owners and operators are aggressively searching for the means to positively impact the bottom line while saving resources and streamlining productivity. There is a growing desire for a linen tracking system that automatically tracks soiled and clean linen items continuously through the linen life cycle. It is desirable to lower the quantity of buffer linen stock (par levels) at hotels while also achieving predetermined service quality standards.

The disadvantages of existing linen management techniques are numerous, including: the inability to count soiled linen, in-house laundry problems, linen sent to outside laundry services are not returned, possibility of pilferages and losses, and the uncertainty in projecting short and long term linen stock levels and finally linen shortage causing customer dissatisfaction.

Uncertainty in arriving stocks levels result in high buffering costs. With such uncertainty, it is difficult to anticipate and plan for optimal linen operations. Many hotels have had to purchase additional stocks of linen to anticipate these daily shortages in an attempt to address this uncertainty. Currently, it is estimated that more than 4 par levels of linen stocks is kept (3 par stock is optimal), increasing the yearly capital expenditure spent on linen.

Resource waste may occur by attempting to resolve linen discrepancies. Such resolution requires significant effect from housekeeping and laundry personnel. Therefore, attention is often diverted from the primary purpose of providing both a high quality linen presentation and offering superior service that high pay hotel guest expect. Opportunity costs include the labor and the often expedited transportation costs that are incurred to rectify the daily discrepancies in linen operations.

In other words, the existing linen management has the following drawbacks.

(1) No knowledge of the life cycle of their linen.

(2) No way to monitor the cost of laundry operations and the effect on the environment.

(3) No way to effectively track discarded and unaccountable items.

(4) No way to insure consistent quality products.

(5) No effective way to track linen as it is processed through the laundry system.

### BRIEF SUMMARY OF THE INVENTION

The present invention overcomes the above mentioned drawbacks and limitation by providing a method and system of tracking hotel moveable assets.

Early assessments of various hotels have shown an overwhelming desire for the benefits that can be realized from “Linentracker®” resource tracking and monitoring system's capability. The system of the present invention enable hotels to significantly increase their effectiveness by streamlining the flow of thousands of expensive, portable, pieces of linen such as sheets, towels, and bathrobes. Hotels perceive the ability to greatly improve linen utilization and increase their ability to meet guest satisfaction goals.

The primary objective of the present invention is that the tracking system is adapted to monitor the movable assets “live” as the assets travel throughout the property, giving key managers complete control.

Another objective of the present invention is that the tracking system will take into account linen and laundry costs, operating efficiency and productivity, as well as guest, staff, and management satisfaction.

Another objective of the present invention is that the tracking system comprises a tracking control communicatively linked with a plurality of check points at different key locations in a hotel, wherein a plurality of identification tags are permanently affixed at the hotel linen products respectively, such that when the hotel linen products are moved to one of the check points, the corresponding identification tags are registered thereat. Therefore, the tracking control is able to monitor and manage the hotel linen products so as to greatly improve linen utilization in the hotel.

Another objective of the present invention is that the tracking system and method is able to keep track with the life cycle of each of the hotel linen products and insure consistent quality products.

Another objective of the present invention is that the tracking system and method is able to keep track the discarded and unaccountable hotel linen products.

Another objective of the present invention is to provide a system and method of tracking hotel linen products, wherein Radio Frequency Identification (RFID) technology is a preferred solution that addresses this concern. The present invention will provide tracking and monitoring of operating supplies, moveable assets, equipment and staff, to enhance the quality of guest services and increase efficiency and productivity, while at the same time reducing operating costs.

Another objective of the present invention is that the system does not store or collect information that is personal in nature. The only information available through the system is the type of linen and the quantity available within a location at a specific property.

Another objective of the present invention is that the system will not communicate to any system to facilitate the transfer of any Malware software or data. In addition, it will be able to abide by the standards of protection required including resident protection and periodic scanning.

The preferred embodiment is a method of tracking hotel linen, comprising the steps of:

(a) communicatively linking a plurality of identification tags with a tracking control in a wireless connection manner;

(b) permanently affixing the identification tags at a plurality of hotel linen products respectively;

(c) setting a plurality of check points at different fixed key locations in a hotel respectively to communicatively link with the tracking control, wherein when each of the hotel linen products is moved to one of the check points, the corresponding identification tag is registered thereat; and

(d) generating a tracking record for the hotel linen products in responsive to each of the check points to monitor and manage the hotel linen products so as to greatly improve linen utilization in the hotel.

The present invention further provides a tracking system for tracking hotel linen, comprising, a tracking control, a plurality of check points setting at different key locations in a hotel respectively to communicatively link with the tracking control, and a plurality of identification tags arranged for permanently affixing at a plurality of hotel linen products respectively.

Each of the identification tags contains a unique code preset by the tracking control to wirelessly communicate with each of the check points, wherein when each of the hotel linen products is moved to one of the check points, the corresponding identification tag is registered thereat. Accordingly, a tracking record is generated in the tracking control for the hotel linen products in responsive to each of the check points to monitor and manage the hotel linen products so as to greatly improve linen utilization in the hotel.

For a more complete understanding of the present invention with its objectives and distinctive features and advantages, reference is now made to the following specification and to the accompanying drawings.

### BRIEF DESCRIPTION OF THE DRAWING(S)

FIG. 1 is a block diagram of the tracking system in accordance with the present invention.

FIG. 2 is a flow diagram of a tracking method in accordance with the present invention.

FIG. 3 is a schematic view to show the structure of the identification tag in accordance with the present invention.

FIG. 4 depicts the routine of the hotel linen product through the tracking system in accordance with the present invention.

### DETAILED DESCRIPTION OF THE INVENTION

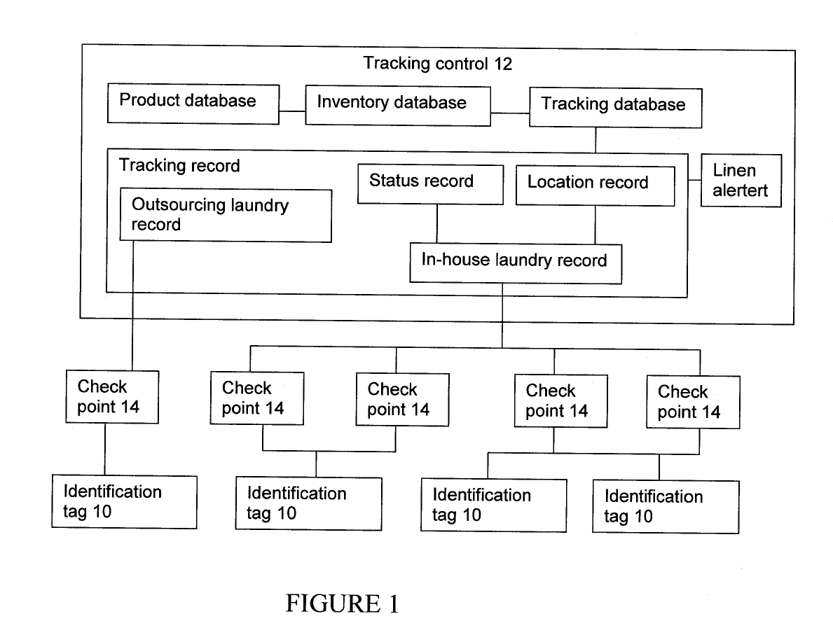

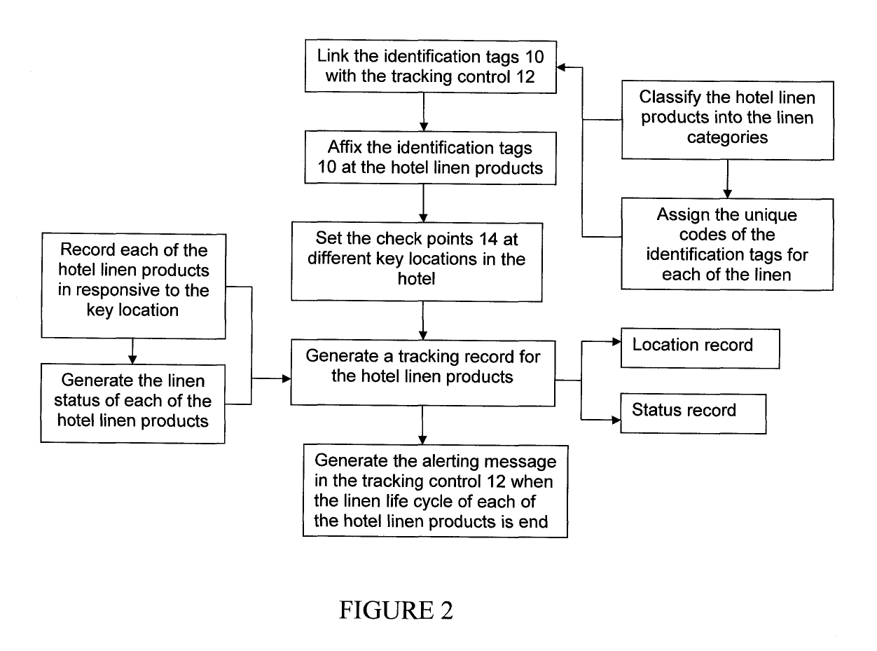

Referring to FIGS. 1 and 2, a system and method of tracking hotel linen products in accordance with the present invention are illustrated, wherein the present enable hotels to significantly increase their effectiveness by streamlining the flow of thousands of expensive, portable, pieces of linen such as sheets, towels, and bathrobes. Hotels perceive the ability to greatly improve linen utilization and increase their ability to meet guest satisfaction goals.

FIG. 1 depicts the tracking system of the present invention, which comprises a tracking control 12, a plurality of check points 14 setting at different key locations in a hotel respectively, and a plurality of identification tags 10, wherein each of the identification tags 10 contains a unique code preset by said tracking control 12.

FIG. 2 depicts the method which comprises the following steps.

(1) Communicatively link the identification tags 10 with the tracking control 12 in a wireless connection manner.

(2) Permanently affix the identification tags 10 at a plurality of hotel linen products respectively.

(3) Set the check points 14 at different key locations in the hotel respectively to communicatively link with the tracking control 12, wherein when each of the hotel linen products is moved to one of the check points 14, the corresponding identification tag 10 is registered thereat.

(4) Generate a tracking record for the hotel linen products in responsive to each of the check points 14 to monitor and manage the hotel linen products so as to greatly improve linen utilization in the hotel.

The tracking control 12 is a main control that incorporates with a server (stand alone) computer being installed in a desired location, such as laundry manager's office or remotely hosted on an internet cloud server, wherein the data will be accesses. The hotel operator is able to track and monitor the inventories of hotel linen products through the tracking control 12. In particularly, the hotel operators will have the opportunity to access the tracking control 12 through an Internet enabled computer by secure login to the tracking control 12. The tracking control 12 can also be remotely monitored by the assigned hotel operators.

The system of the present invention is designed around using RFID technology to identify the hotel linen products within the hotel. The RFID technology component comprises a microchip that has an ID and RFID readers/antennas that can receive the ID as a radio signal from the microchip to identify the microchip. The system is fully FCC compliant. The architecture of the system is designed to have RFID antennas listening to RFID microchips at the key locations within the hotel. This will allow the system to compile inventory information of the hotel linen products that will be available for property managers to review and understand utilization information. The system works within a self contained network and does not have to connect to the corporate network for any information.

In the preferred embodiment, the identification tags 10 are RFID tags wirelessly read at each of the check points 14 using radio waves. Each of the identification tags 10 is affixed to an edge portion of the hotel linen product. Accordingly, for existing lien inventories, a special encapsulated programmed RFID SMARTtag is affixed to all hotel linen on property. Preferably, a static IP address is assigned to each of the check points 14 so the RFID data thereat will be transferred through the properties network to the designated server.

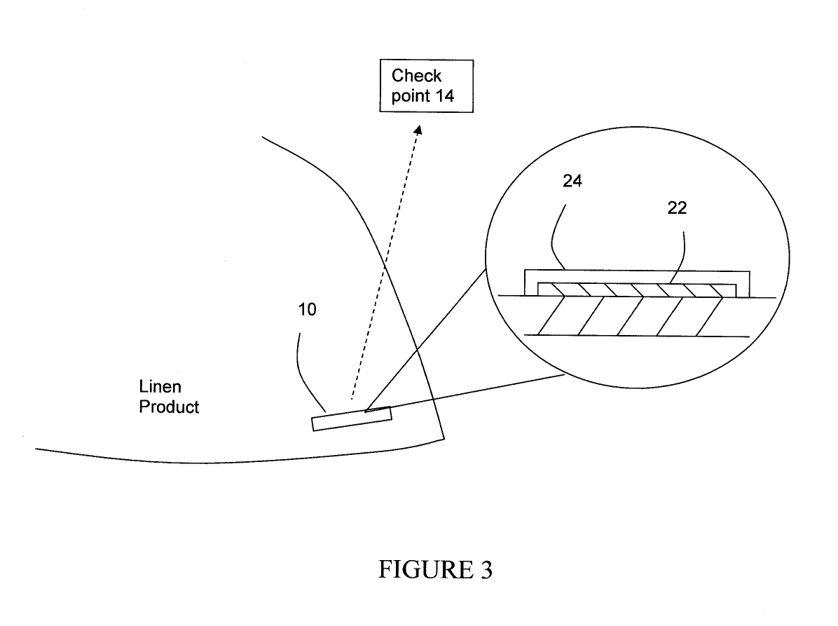

FIG. 3 depicts each of the identification tags 10 comprising a microchip 22 adapted to be registered with each of the check points 14 in a wirelessly communicating manner, and a protection sleeve 24, which is made of waterproof and heat resistant material, containing the microchip 22 therein, wherein the protection sleeve 24 is sealed and affixed to each of the hotel linen products to retain the microchip 22 thereat and to protect the microchip 22 for laundry process. Preferably, the protection sleeve 24 is made of silicon to protect and retain the microchip 22 at the respective hotel linen product.

For software communication overview, the check points 14 as the RFID readers/antennas that receive signals from the microchips 22 of the identification tags 10 are Ethernet based devices that transmit the ID's collected from the microchips 22 to the tracking control 12 for storage and analysis. The tracking control 12 will periodically poll individual check points 14 for their inventory information. To facilitate this each check point 14 will have its individual Ethernet address to communicate. The system of the present invention will not access any corporate network, but rather leverage the existing property network to communicate.

In addition, the check points 14 are set at the key locations of the hotel in responsive to linen closets, laundry chute room and laundry sort areas in the hotel. In particularly, the cleaning process of the hotel linen products is that the hotel linen product passes into laundry machine, dryer, and press folder. Therefore, when the hotel linen products are moved to the linen closets, the check points thereof will read the identification tags 10 to track the quantity of the hotel linen products in the linen closets. Preferably, the check point 14 is also set at each of the hotel rooms to ensure the hotel linen products being replaced daily and to prevent the hotel linen products from being stolen. It is worth mentioning that the protection sleeve 24 will protect the microchip 22 from being damaged through the cleaning process of the hotel linen product.

For sorting out different kinds of hotel linen products, the method of the present invention, in the step (1), further comprises the following sub-steps.

(1-1) Classify the hotel linen products into a plurality of linen categories. Accordingly, the hotel linen products are classified, as an example, into a sheet category, a towel category, and a bathrobe category, etc. . . .

(1-2) Assign the unique codes of the identification tags for each of the linen categories.

In the preferred embodiment, the tracking control 12 comprises an inventory database for storing information of the hotel linen products with manufacture, style, size, cost, and date of manufacture. In addition, the tracking control 12 further comprises a tracking database and a product database storing information of the hotel linen products that the hotel linen products are classified into the linen categories.

Therefore, when each of the hotel linen products is read from one of the check points 14 to another check point 14, the tracking control 12 not only identifies the hotel linen product in responsive to the key location 14 for tracking purpose but also manages the hotel linen product in responsive to the linen category for real-time monitoring inventory purpose.

For example, the check point 14 at the linen closet will read the hotel linen products with different unique codes of the identification tags 10. Therefore, the tracking control 12 is able to track the quantity of the sheets, towels, and bathrobes within the respective linen closet.

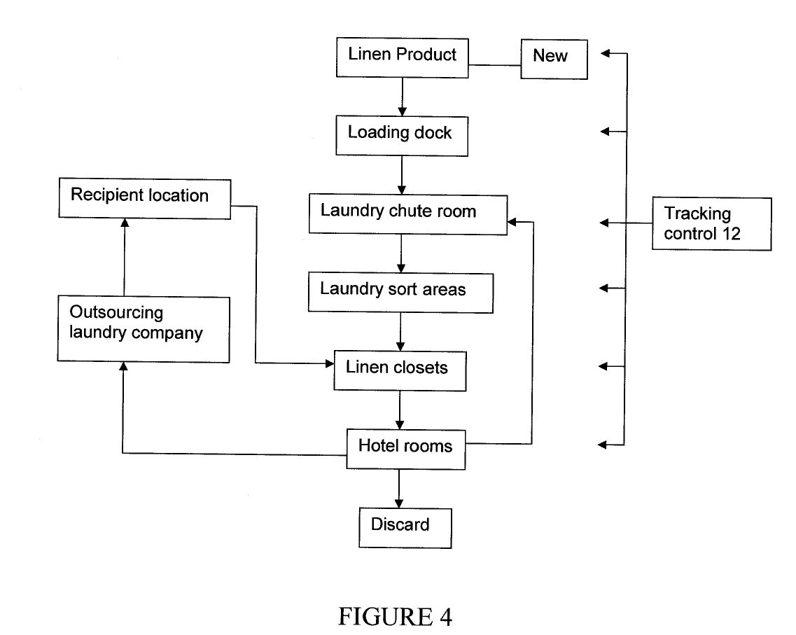

Having the check points 14 at different key locations of the hotel, the tracking control 10 is able to track the linen status of the hotel linen product as shown FIG. 4. When a new (embedded) linen product arrives at the loading dock of the hotel, it will pass through a scan field and the amount received is noted on the tracking control 10 as “received new”. The tracking control 10 will indicate the quantity of new linen product in the hotel. The new linen product is then placed in the laundry chute room or dirty linen sort area and the tracking control 10 will read dirty via the check points 14. Then, the linen product passes into laundry machine, dryer and press folder. Once the wash process is completed, the linen product will move back up to the linen closets on the floors. Upon its arrival in the linen closet to register with the check points 14 thereat, the tracking control 10 will automatically adjust the dirty status to clean status. In addition to clean-dirty status, the tracking control 10 will also provide location tracking via the check points 14 so the management will know the exact location of each linen product. In other words, the system will monitor the movements of all hotel linen products as they pass throughout the check points 14 of the hotel for complete real-time inventory management.

In responsive to track the linen status of the hotel linen product, the step (4) of the method of the present invention comprises the following sub-steps.

(4-1) Record each of the hotel linen products in responsive to the key location when the identification tag 10 is registered with the corresponding check point 14. Therefore, the tracking control 12 is able to keep track the quantity of the hotel linen products and the locations thereof at the respective check point 14.

(4-2) Generate the linen status of each of the hotel linen products in responsive to the key location to verify a condition of the hotel linen product. As it is mentioned, the status of hotel linen products at the laundry chute room will be stated as dirty status. The status of hotel linen products at the linen closet will be stated as clean status.

Furthermore, the tracking record of the tracking control 12 contains a location record containing data of each of the hotel linen products in responsive to the key location when the identification tag 10 is registered with the corresponding check point 14, and a status record containing data of the linen status of each of the hotel linen products in responsive to the key location to verify the condition of the hotel linen product.

Since the hotel linen products must be discarded frequently due to laundry damage or normal wear and tear, each of the hotel linen products has its own linen life cycle preset in the tracking control 12. Therefore, the hotel operator must discard the damaged hotel linen product once the linen life cycle thereof is end. Accordingly, the tracking control 12 comprises a linen alerter communicatively linked to the tracking record to keep track the linen life cycle of each of the hotel linen products, wherein the linen alerter generates an alerting message in the tracking control 12 when the linen life cycle of each of the hotel linen products is end for enhancing a quality control of the hotel linen products and for achieving high service quality standards for guests in the hotel. Correspondingly, the method should also contain a step of generating the alerting message in the tracking control 12 when the linen life cycle of each of the hotel linen products is end. For example, a bed sheet is set in the tracking control 12 to have 50 laundry cycles. Once the bed sheet passes through the check point 14 at the laundry chute room for 50 times, the tracking control 12 will generate the alerting message for discarding the bed sheet.

Accordingly, some hotels are utilizing on-site laundry facilities, while other are outsourcing. The present invention is able to keep track the hotel linen products through both the on-site laundry facility and outsourcing laundry facility. The tracking record further contains an in-house laundry record for tracking the hotel linen products through an in-house laundry process in responsive to the different check points, and an outsourcing laundry record for tracking the hotel linen products in outsourcing laundry manner. The in-house laundry record will provide all statuses of the hotel linen products through the above mentioned clean process. The outsourcing laundry record will provide the dirty status of the hotel linen products and will record the quantity and the send-out date of the dirty hotel linen products. The outsourcing laundry record also provides the information of the outsourcing laundry company and a projected delivery date of the hotel linen products. Once the hotel linen products are cleaned and returned back to the hotel, the hotel linen products are registered at the check point 14 of the recipient location of the hotel. The tracking control 12 will verify the unique codes of the identification tags 10 of the sent hotel linen products with the unique codes of the identification tags 10 of the returned hotel linen products. Then, the returned hotel linen products will be sent back to the linen closets to update the linen status of the hotel linen products.

The present invention will provide personally identifiable information protection. The system of the present invention does not store or collect information that is personal in nature. The only information available through the system is the type of linen product and the quantity available within the key location at the hotel. The identification tag 10 only carries the unique code that identifies the linen product. This unique code is the only data that is transferred from the check point 14 to the tracking control 12. In this capacity, external scanning of the identification tag 10 will not provide any information either about the linen product or its history.

For malware protection, the system of the present invention will not communicate to any system to facilitate the transfer of any Malware software or data. In addition, the present invention will be able to abide by the standards of protection required including resident protection and periodic scanning.

The present application utilizes UHF (Ultra High Frequency) RFID (Radio Frequency Identification) solution works to track and monitor in real-time hotel linen products (laundry) specifically in hospitality and other industries that may apply (hospitals, health and fitness clubs, and spas) wherever softline assets are used.

The present application system works utilizing UHF long range RFID and has achieved an averaging read range of 4 meters.

The present application works were items are tracked in free space where no human intervention is needed.

The present application enables antennas to be set up at various locations throughout a property where as hotel linen products pass they will be recorded at that location and will change status based on the business process in the linen life cycle. (Clean, Dirty, In Use)

The present application is be able to link a combination of RFID tags, each with its own unique ID# in a wireless manner, by permanently affixing them to a combination of assorted hotel linen products which can pass certain fixed checkpoints at different locations in a hotel environment. If a product is moved to one of several locations, the corresponding tag is registered.

The RFID SMARTtag inlay that the present application uses works on UHF frequency greater than 800 MHz and can endure 550 washed at 50 bars of pressure in a tunnel washer extractor. Additionally, the SMARTtag of the present application used inductive resonance as a way to connect the microchip to the antenna.

The hardware used in present application works by directly connecting to a cloud server allowing for an internet hosted cloud solution. There is no need for a local server to be located at the physical location of the deployment. A customer user can simply login to a secured internet site (URL address) and view data specifically to their property location.

The present application to show the method and system of tracking hotel linen products in a closed loop is clearly defined, and can be translated to any establishment where linen and textiles are reused and washed in the industrial environment. Additionally, the present application enables monitoring asset piece counts without the need for physically counting each individual linen product.

The present application enables linen baskets full with linen and other assets to be read at greater than 98% accuracy.

The present application utilizes several types of RFID antennas (of various sizes) to work with the solution that provide several functions based on the location. These RFID antennas will be mounted at different angles on ceilings, walls and floors giving assets the best chance to be seen by radio waves to wirelessly communicate with the identification tags. The present application further provides a RFID enabled floor mat where items can travel over this area and be automatically scanned by the system.

The present application utilizes a surround portal technology specifically designed to scan everything placed inside a unit within a matter of seconds. Linen Technology Tracking has designed a surround portal where a box is constructed consisting of (3) walls and a roof along with a curtain closure on the open side. When items are placed inside will scan with greater than 98% accuracy.

The present application utilizes linen closet storage functionality. Assets are securely stored prior to use in linen locker/closets of various sizes. The present application monitors the total number of assets inside the lockers in real time. When an employee comes to the locker they are asked to swipe their employee ID card or RFID enabled ID badge to gain access. Upon their entry the present application providing a software solution identifies the employee and recognizes the number and specific assets taken from this secured storage locker. The software solution updates the new value inside the locker so that this information is up to date in real-time on the web hosted dashboard.

The present application does not require a user (employee) to be held responsible for making sure the quantities are recorded correctly by using his or hers smartcard at the location of the reader. The present application conversely uses the UHF RFID technology with the far read range to track the employee as they pass through the same check points that the linen passes. Indeed, the present application has the ability to coordinate the movement of items of specific employees by monitoring the real time events that transpire, i.e. an employee collection of items at the closet level can be detected both on an item level as well as employee level.

The present application will read multiple assist across several physical locations. For example if a hotel company has several properties, the total assets in all properties can be seen on the web hosted dashboard as a corporate view and see the total assets for this organization as well as drill down into the data for each specific location. Individual locations can be identified uniquely and all assets currently in each location will show as they are represented. This will give hotel owners the ability to manage asset value across their total operation.

The present application also works with locations where services are performed on inventory assets. For example: A hotel sends their linen assets to an outside laundry company. When the assets depart the hotel they are recorded as (Dirty) and change status to (Laundry). Upon the assets arrival at the Laundry location this item will be scanned and the physical location will show (Dirty Laundry) Location and change status to (Dirty Laundry) and later move into the (Wash) status. This will be represented on the dashboard of the hotel showing it is currently at the outside laundry being washed. Upon completion of the washing process the outside laundry will scan the assets and the physical location will show (Clean Laundry) Location and change status to (Clean Laundry) and later move into the (Hotel) status showing they were sent back to the hotel location. Upon arriving at the hotel location these assets will be read by the physical location (Hotel Loading Dock) and switch to (Clean) status and continue through the life cycle.

The present application can use any form of collecting bin without height restriction, or material composition and without the need for attaching antennas to the inner walls. Using UHF RFID enabled readers and antennas. The present application is capable of reading full bin loads as it rolled into a location with high powered antennas affixed either on ceiling and walls or built into a fixed portal structure in which the cart is rolled into. The present application will eliminate the need for handling biohazard materials i.e. bed sheets, surgical linens etc collected at hospitals and will not require employees to endanger themselves by placing these soiled items in bags

The present application utilizes visual monitors placed throughout a property where asset data will be shown for staff to utilize and assist in the operation and enable efficiencies.

The present application utilizes audio sounds to alert managers and staff when assets pass through a given location.

The present application functions in conditions where weather is not favorable inside or outside. All hardware is waterproof and has been tested in extreme conditions.

The present application uses specific calculations to determine a unique logic which insures each asset reflects the specific status based on specific location and time in the life cycle.

The present application adds value to customers by interpreting the data collected by the system and presenting these findings to improve operations.

The present application is complemented by the company's ability to manufacture the actual linen assets that will be tracked by the solution. These linen assets will have embedded with proprietary “Linentracker® UHF SMARTtags”.

The present application can also be deployed to work in an automatic dispensing unit. In this case, assets are stored inside a closed unit. Users would enter an identification number into a key pad and the unit would open where user would remove several assets. Upon the door closing the unit would record specific user removed (x) assets and there remains (x). Upon the users return they would simply drop assets into another compartment inside the close unit and user would be given credit for assets checked out.

Furthermore, the present application ability to generate a tracking record for the hotel linen products in response to each of the check points and to monitor in real-time and manage said hotel linen products, can therefore greatly improve linen utilization and employee efficiency in the hotel.

The present application will read multiple assists with a hand held UFH RFID reader (scanner). Inventory can be audited by simply placing a handheld scanner in the area where assets are available and the total count will appear on the screen. A software application will link the information wirelessly (via Bluetooth and WiFi) to the cloud server and this data will be added to the dashboard of the present application.

The present application is a scalable model where customers add value to the model as each property/customer will install the necessary RFID hardware. Linen Technology Tracking will remotely program each reader and send to the location where it will be plugged into the internet and the system will begin recording information from the property “live” in a matter of minutes.

The present application is able to remotely trouble shoot problems properties/customers are experiencing without the expense of travel to their physical locations.

The present application compiles a configuration guide for each property/customer with outlines the solution and its functionality. The present application offers the ability for customer to make enhancements to specific reports and reports and these additions will be reflected across the complete network enhancing the overall software solution.

The present application can provide operators of health clubs, gyms etc. with the ability to control such losses. The present application allow for read ranges great enough to capture the losses when an individual exits the front door. This can only be provided with the present application that uses UHF Ultra High Frequency RFID for reading distances greater than 6 to 8 feet.

In any event, the configuration of the present application is simple and easy to use, which is more easy to configure and at a lower cost, yet, the present application not only perfectly solves the existing problems of linen management in hotel industry by permanently affixing the SMARTtags to a combination of assorted hotel linen products and by setting different fixed checkpoints at different locations in the hotel environment, but also provides sufficient tracking solution by registering the corresponding SMARTtag at different fixed checkpoints at different locations in the hotel environment when the products is moved to one of several locations.

While the embodiments and alternatives of the present invention have been shown and described, it will be apparent to one skilled in the art that various other changes and modifications can be made without departing from the spirit and scope of the present invention.

What is claimed is:

1. A linen tracking method, comprising the steps of:
(a) communicatively linking a plurality of identification tags with a tracking control in a wireless connection manner;
(b) affixing said identification tags at a plurality of linen products respectively;
(c) setting a plurality of check points at various fixed key locations in a property respectively to communicatively link with said tracking control, wherein a linen status of each of said linen products is identified at each of said check points at said corresponding fixed key location, wherein when each of said linen products is moved from one of said fixed key locations to another said fixed key location, said corresponding identification tag is registered at said corresponding said check point to change said linen status; and
(d) generating a tracking record for said linen statuses said linen products in responsive to each of said check points to monitor and manage said linen products.

2. The method of claim 1 wherein said identification tags are UHF (Ultra High Frequency) long range RFID tags wirelessly read at each of said check points.

3. The method of claim 1 wherein a plurality of antennas are set up at said fixed key locations throughout said property where as said linen products pass they are recorded at said fixed key location and their status are changed correspondingly.

4. The method of claim 2 wherein a plurality of antennas are set up at said fixed key locations throughout said property where as said linen products pass they are recorded at said fixed key location and their status are changed correspondingly.

5. The method of claim 4 wherein each of said antennas is fixed at said fixed key location at an area selected from the group consisting of ceilings, walls, floors, and floor mat.

6. The method of claim 1 wherein the step (a) comprises the sub-steps of:
(a-1) classifying said linen products into a plurality of linen categories; and
(a-2) assigning unique codes of said identification tags for each of said linen categories; wherein when each of said linen products is read from one check point to another check point, said tracking control not only identifies said linen product in responsive to said key location for tracking purpose but also manages said linen product in responsive to said linen category for real-time monitoring inventory purpose.

7. The method of claim 1 wherein the step (d) comprises the sub-steps of:
(d-1) recording each of said linen products in responsive to said key location when said identification tag is registered with said corresponding check point; and
(d-2) updating said linen status of each of said linen products in responsive to said key location to verify a condition of said linen product.

8. The method of claim 1 further comprising a step of generating an alerting message in said tracking control when a linen life cycle of each of said linen products is end.

9. The method of claim 1 wherein said check points are set at said key locations of said property selected from the group consisting of linen closets, laundry chute room and laundry sort areas in said property.

10. The method of claim 1 wherein, in the step (d), said tracking record contains an in-house laundry record for tracking said linen products through an in-house laundry process in responsive to said different check points, and an outsourcing laundry record for tracking said linen products in outsourcing laundry manner.

11. The method of claim 1 wherein said tracking control comprises an inventory database storing information of said linen products with manufacture, style, size, cost, and date of manufacture.

12. The method of claim 1 wherein each of said identification tags comprises a microchip adapted to be registered with each of said check points in a wirelessly communicating manner, and a protection sleeve, which is made of waterproof and heat resistant material, containing said microchip therein, wherein said protection sleeve is sealed and affixed to each of said linen products to retain said microchip thereat and to protect said microchip.

13. A linen tracking system, comprising:
a tracking control;
a plurality of check points setting at different fixed key locations in a property respectively to communicatively link with said tracking control;
a plurality of identification tags arranged for affixing at a plurality of linen products respectively and arranged in such a manner that when each of said linen products is moved from one of said fixed key locations to another fixed key location, said corresponding identification tag is registered at said corresponding said check point to identify a linen status of each of said linen products at each of said check points of said corresponding fixed key location, wherein a tracking record is generated in said tracking control for said linen products in responsive to each of said check points to monitor and manage said linen products.

14. The linen tracking system of claim 13 wherein said identification tags are UHF (Ultra High Frequency) long range RFID tags wirelessly read at each of said check points.

15. The linen tracking system of claim 14 further comprising a plurality of antennas set up at said fixed key locations throughout said property where as said linen products pass they are recorded at said fixed key location and their status are changed correspondingly.

16. The tracking system of claim 13 wherein said check points are set at said key locations of said property selected from the group consisting of linen closets, laundry chute room and laundry sort areas.

17. The tracking system of claim 13 wherein each of said identification tags comprises a microchip adapted to be registered with each of said check points in a wirelessly communicating manner, and a protection sleeve, which is made of waterproof and heat resistant material, containing said microchip therein, wherein said protection sleeve is sealed and affixed to each of said linen products to retain said microchip thereat and to protect said microchip.

18. The tracking system of claim 13 wherein said tracking control comprises a linen alerter communicatively linked to said tracking record to keep track a linen life cycle of each of said linen products, wherein said linen alerter generates an alerting message in said tracking control when said linen life cycle of each of said linen products is end.

19. The tracking system of claim 13 wherein said tracking control comprises a tracking database and a product database storing information of said linen products that said linen products are classified into a plurality of linen categories, wherein unique codes of said identification tags are assigned for each of said linen categories, such that when each of said linen products is read at one of said check points, said tracking control not only identifies said linen product in responsive to said key location for tracking purpose in said tracking database but also manages said linen product in responsive to said linen category for real-time monitoring inventory purpose.

20. The tracking system of claim 13 wherein said tracking record contains a location record containing data of each of said linen products in responsive to said key location when said identification tag is registered with said corresponding check point, and a status record containing data of said linen status of each of said linen products in responsive to said key location to verify a condition of said linen product.

21. The tracking system of claim 13 wherein said tracking record further contains an in-house laundry record for tracking said linen products through an in-house laundry process in responsive to said different check points, and an outsourcing laundry record for tracking said linen products in outsourcing laundry manner.
